(19) United States
(12) Patent Application Publication
(10) Pub. No.: US 2025/0173576 A1
(43) Pub. Date: May 29, 2025

(54) CREATION OF HOMOGENEOUS SESSIONS USING MACHINE LEARNING (ML) MODEL

(71) Applicant: SONY GROUP CORPORATION, Tokyo (JP)

(72) Inventors: BRIJRAJ SINGH, Bengaluru (IN); Sonal Dabral, Bengaluru (IN); Naoyuki Onoe, Bengaluru (IN)

(21) Appl. No.: 18/521,114

(22) Filed: Nov. 28, 2023

(51) Int. Cl. G06N 3/092

(52) U.S. Cl. CPC G06N 3/092

(57) ABSTRACT

An electronic device and a method for creation of homogeneous sessions using machine learning (ML) model is disclosed. The electronic device receives interaction information of a set of users for a set of items. The electronic device receives a textual description of each item. The electronic device determines an embedding vector associated with each item. The electronic device clusters the determined embedding vector. The electronic device applies a reinforcement learning model on the set of labels. The electronic device determines a set of session slots associated with the received interaction information of the set of users. The electronic device applies a sequential model on the set of session slots associated with the received interaction information of the set of users. The electronic device determines a set of recommended items for a user of the set of users. The electronic device renders the determined set of recommended items.

### FIELD

Various embodiments of the disclosure relate to determination of sessions. More specifically, various embodiments of the disclosure relate to creation of homogeneous sessions using machine learning (ML) model.

### BACKGROUND

Advancements in the field of artificial intelligence have led to development of different types of machine learning (ML) models such as recommendation models. A typical recommendation model may recommend a set of items for a user based on user interactions extracted from one or more sessions associated with the user. A session may be started from a time instant that a user may start to interact with at least one item through a platform (e.g., an over-the-top platform). Further, each session may be associated with a fixed time duration. In an example, the fixed time duration may be thirty minutes. Herein, a first session may correspond to a time interval between a first time instant from which the user may start to interact with at least one item through the platform to a second time instant. The second time instant may be thirty minutes after the first time instant. Further, a second session may include a time duration of thirty minutes after the end of the first session. Such sessions may be received and provided to the recommendation model. The recommendation model may recommend one or more items to the user based on user interactions associated with the provided sessions. However, each user may exhibit different behavioral pattern associated with interacting with items on the platform. For example, a teenage user may exhibit erratic behavior and may thus spend considerably lesser amount of time on various items than a middle-aged user. For example, the teenage user may switch from one item to another item within a very short span of time, such as, a few seconds. However, the middle-aged user may exhibit a stable behavioral pattern and may spend a minute on analysis of the item. Therefore, a number of interactions for each individual may vary within the fixed time duration. Thus, a size of a session may vary from individual to individual. Therefore, the session associated with the fixed time duration may include similar items for some users and may include mixed items for other users.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for creation of homogeneous sessions using machine learning (ML) model is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for creation of homogeneous sessions using machine learning (ML) model, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for creation of homogeneous sessions using machine learning (ML) model, in accordance with an embodiment of the disclosure.

FIG. 4 is a diagram that illustrates an exemplary scenario for determination of set of session slots, in accordance with an embodiment of the disclosure.

FIG. 5 is a diagram that illustrates an exemplary scenario for creation of homogeneous sessions using machine learning (ML) model, in accordance with an embodiment of the disclosure.

FIG. 6 is a diagram that illustrates an exemplary scenario for recommendation of items based on an application of a hierarchical recurrent neural network (HRNN), in accordance with an embodiment of the disclosure.

FIG. 7 is a flowchart that illustrates operations of an exemplary method for creation of homogeneous sessions using machine learning (ML) model, in accordance with an embodiment of the disclosure.

### DETAILED DESCRIPTION

The following described implementation may be found in an electronic device and method for creation of homogeneous sessions using machine learning (ML) model. Exemplary aspects of the disclosure may provide an electronic device that may receive interaction information of a set of users for a set of items. The electronic device may receive a textual description of each item of the set of items. The electronic device may determine an embedding vector associated with each item of the set of items based on the received textual description. The electronic device may cluster the determined embedding vector associated with each item of the set of items into a set of labels. The electronic device may apply a reinforcement learning model on the set of labels based on the clustering of the determined embedding vector. The electronic device may determine a set of session slots associated with the received interaction information of the set of users, based on the application of the reinforcement learning model. The electronic device may apply a sequential model on the set of session slots associated with the received interaction information of the set of users. The electronic device may determine a set of recommended items for a user of the set of users, based on the application of the sequential model. The electronic device may render the determined set of recommended items.

Typically, a recommendation model may recommend a set of items for a user based on user interactions extracted from one or more sessions associated with the user. A session may start from a time instant a user starts to interact with at least one item through a platform. Further, each session may be associated with a fixed time duration. In an example, the fixed time duration may be thirty minutes. Herein, a first session may correspond to a time interval between a first time instant from which the user may start to interact with at least one item through the platform to a second time instant. The second time instant may be thirty minutes after the first time instant. Further, a second session may include a time duration of thirty minutes after the second time instant. Such sessions may be received and provided to the recommendation model. The recommendation model may recommend one or more items to be used based on user interactions associated with the provided sessions. However, each user may exhibit different behavioral pattern associated with interacting with items on the platform. For example, a teenage user may exhibit erratic behavior and may thus spend considerably lesser amount of time on various items than a middle-aged user. For example, the teenage user may switch from one item to another item within a very short span of time, such as, a few seconds. However, the middle-aged user may exhibit a stable behavioral pattern and may spend a minute on analysis of the item. Therefore, a number of interactions for each individual may vary within the fixed time duration. Thus, a size of a session may vary from individual to individual. Therefore, the session associated with the fixed time duration may include similar items for some users and may include mixed items for other users.

In order to address the abovementioned issues, the disclosed electronic device may employ a machine learning (ML) model for creation of homogeneous sessions. The electronic device may employ the reinforcement learning model to determine the set of session slots associated with the received interaction information of the set of users. A length of each session slot of the determined set of session slots may be customized according to an interaction pattern of a user associated with the corresponding session slot. That is, a size of two or more session slots of the set of session slots may differ. In an example, the set of users may include a teenage user and a middle-aged user. The teenage user may have an erratic interaction behavior and the middle-aged user may have a stable interaction behavior. That is, the teenage user may switch from one item to another quicker than the middle-aged user. Therefore, the size of the determined set of session slots associated with the teenage user may be smaller than the determined size of the set of session slots associated with the middle-aged user. Further, the size of the determined set of session slots may vary according to a mood of the user associated with the set of session slots. The determined set of session slots may be fed as an input to the sequential model to determine the set of recommended items for a user of the set of users. The set of recommended items, such as, movies may be rendered on an over-the-top (OTT) platform. As each session slot may correspond to a single type of items (e.g., an action movie, or comedy movie), the recommendations made based on such homogenous slots may have a higher accuracy and relevance for the particular user. In other words, cohesive session slots with a single dominating category of items may help to recommend items that may be more likable to the users.

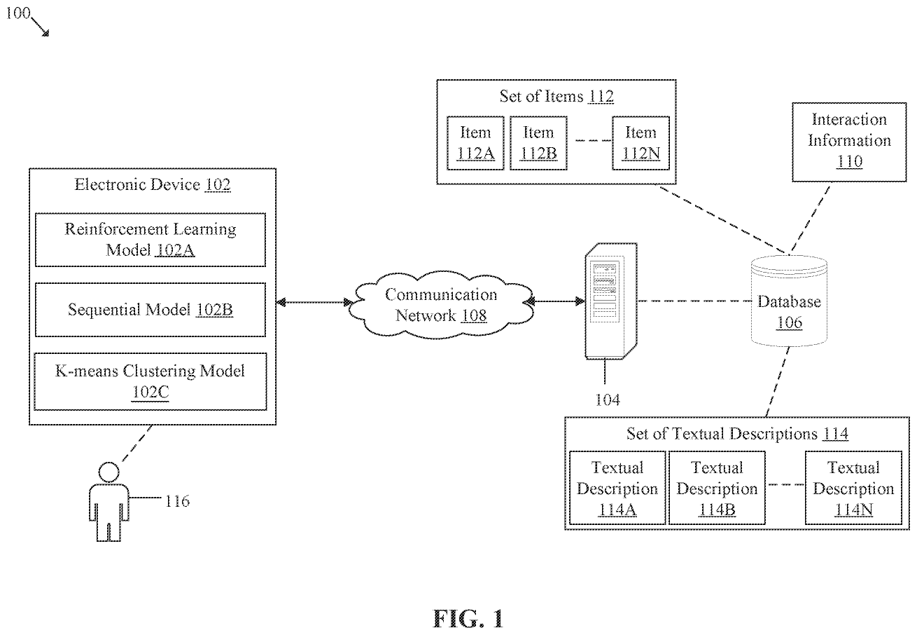

FIG. 1 is a block diagram that illustrates an exemplary network environment for creation of homogeneous sessions using machine learning (ML) model, in accordance with an embodiment of the disclosure. With reference to FIG. 1, there is shown a network environment 100. The network environment 100 may include an electronic device 102, a server 104, a database 106, and a communication network 108. The electronic device 102 may communicate with the server 104 through one or more networks (such as, a communication network 108). The electronic device 102 may include a reinforcement learning model 102A, a sequential model 102B, and a K-means clustering model 102C. In FIG. 1, there is further shown interaction information 110, a set of items 112, and a set of textual descriptions 114, that may be stored in the database 106. The set of items 112 may include an item 112A, an item 112B, . . . , and an item 112N. Further, the set of textual descriptions 114 may include a textual description 114A, a textual description 114B, . . . , and a textual description 114N. The textual description 114A may be associated with the item 112A, the textual description 114B may be associated with the item 112B, . . . , and the textual description 114N may be associated with the item 112N.

The N number of items and the N number of textual descriptions shown in FIG. 1 are presented merely as an example. The database 106 may include only two or more than N items and textual descriptions, without deviation from the scope of the disclosure. For the sake of brevity, only N items and textual descriptions have been shown in FIG. 1. However, in some embodiments, there may be more than N items and textual descriptions without limiting the scope of the disclosure. In FIG. 1, there is further shown a user 116, who may be associated with or may operate the electronic device 102.

The electronic device 102 may include suitable logic, circuitry, interfaces, and/or code that may be configured to receive the interaction information 110 of a set of users for the set of items 112. The electronic device 102 may receive the textual description (such as, the textual description 114A) of each item (such as, the item 112A) of the set of items 112. The electronic device 102 may determine an embedding vector associated with each item (for example, the item 112A) of the set of items 112 based on the received textual description (for example, the textual description 114A. The electronic device 102 may cluster the determined embedding vector associated with each item of the set of items 112 into a set of labels. The electronic device 102 may apply the reinforcement learning model 102A on the set of labels based on the clustering of the determined embedding vector. The electronic device 102 may determine a set of session slots associated with the received interaction information 110 of the set of users, based on the application of the reinforcement learning model 102A. The electronic device 102 may apply the sequential model 102B on the set of session slots associated with the received interaction information 110 of the set of users. The electronic device 102 may determine a set of recommended items for a user (for example, the user 116) of the set of users, based on the application of the sequential model 102B. The electronic device 102 may render the determined set of recommended items.

Examples of the electronic device 102 may include, but are not limited to, a computing device, a smartphone, a cellular phone, a mobile phone, a gaming device, a mainframe machine, a server, a computer workstation, a machine learning (ML)-capable device (enabled with or hosting, for example, a computing resource, a memory resource, a networking resource, and/or one or more machine learning models), and/or a consumer electronic (CE) device.

The server 104 may include suitable logic, circuitry, and interfaces, and/or code that may be configured to receive the interaction information 110 of the set of users for the set of items 112. The server 104 may receive the textual description (such as, the textual description 114A) of each item (such as, the item 112A) of the set of items 112 The server 104 may determine the embedding vector associated with each item (for example, the item 112A) of the set of items 112 based on the received textual description (for example, the textual description 114A. The server 104 may cluster the determined embedding vector associated with each item of the set of items 112 into the set of labels. The server 104 may apply the reinforcement learning model 102A on the set of labels based on the clustering of the determined embedding vector. The server 104 may determine the set of session slots associated with the received interaction information 110 of the set of users, based on the application of the reinforcement learning model 102A. The server 104 may apply the sequential model 102Bon the set of session slots associated with the received interaction information 110 of the set of users. The server 104 may determine the set of recommended items for the user 116 of the set of users, based on the application of the sequential model 102B. The server 104 may render the determined set of recommended items.

The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the interaction information 110, the set of items 112, and the of textual descriptions 114. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for the interaction information 110, the set of items 112, and/or the textual descriptions 114 from the electronic device 102. In response, the device of the database 106 may be configured to retrieve and provide the queried interaction information 110, the set of items 112, and/or the textual descriptions 114 to the electronic device 102, based on the received query.

In some embodiments, the database 106 may be hosted on a plurality of servers stored at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102 and the server 104 may communicate with one another. The communication network 108 may be one of a wired connection or a wireless connection. Examples of the communication network 108 may include, but are not limited to, the Internet, a cloud network, Cellular or Wireless Mobile Network (such as Long-Term Evolution and 5^{th} Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The reinforcement learning model 102A may be a machine learning (ML) model that may be a classifier model which may be trained to identify a relationship between inputs, such as features in a training dataset and output labels, such as the set of session slots. The reinforcement learning model 102A may be defined by its hyper-parameters, for example, number of weights, cost function, input size, number of layers, and the like. The parameters of the reinforcement learning model 102A may be tuned and weights may be updated so as to move towards a global minima of a cost function for the reinforcement learning model 102A. After several epochs of the training on the feature information in the training dataset, the reinforcement learning model 102A may be trained to output classification result for a set of inputs.

The reinforcement learning model 102A may include electronic data, which may be implemented as, for example, a software component of an application executable on the electronic device 102. The reinforcement learning model 102A may rely on libraries, external scripts, or other logic/instructions for execution by a processing device. The reinforcement learning model 102A may include code and routines configured to enable a computing device to perform one or more operations such as, determination of the set of session slots. Additionally, or alternatively, the reinforcement learning model 102A may be implemented using hardware including a processor, a microprocessor (e.g., to perform or control performance of one or more operations), a field-programmable gate array (FPGA), or an application-specific integrated circuit (ASIC). Alternatively, in some embodiments, the reinforcement learning model 102A may be implemented using a combination of hardware and software.

In an embodiment, the reinforcement learning model 102A may be a NN model. The neural network may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before, while training, or after training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to same or a different same mathematical function.

In training of the neural network, one or more parameters of each node of the neural network may be updated based on whether an output of the final layer for a given input (from the training dataset) matches a correct result based on a loss function for the neural network. The above process may be repeated for same or a different input until a minima of loss function may be achieved, and a training error may be minimized. Several methods for training are known in art, for example, gradient descent, stochastic gradient descent, batch gradient descent, gradient boost, meta-heuristics, and the like.

The neural network may include electronic data, which may be implemented as, for example, a software component of an application executable on the electronic device 102. The neural network may rely on libraries, external scripts, or other logic/instructions for execution by a processing device. The neural network may include code and routines configured to enable a computing device to perform one or more operations for determination of the set of session slots. Additionally, or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software.

The sequential model 102Bmay be a computational network or a system of artificial neurons, arranged in the set of NN layers, as nodes. The sequential model 102Bmay be applied on the set of session slots associated with the received interaction information of the set of users. Based on the application of the sequential model 102B, the set of recommended items for a user of the set of users may be determined. In an embodiment, the sequential model 102Bmay be at least one of a hierarchical recurrent neural network (HRNN), a recurrent neural network (RNN), a short-term attention/memory priority (STAMP) model, a neural attentive recommendation machine (NARM) model, or a transformer model. The HRNN may be a stack of RNN that may be used for modelling sequential data. The RNN may be a type of neural network that may be associated with memory. Herein, an output of a previous step of the RNN may be fed to an input layer of the RNN at a current step. Further details related to the sequential model 102Bmay be similar to the reinforcement learning model 102A without departure from the scope of the disclosure. Hence, such details have been omitted for the sake of brevity of the disclosure.

The K-means clustering model 102C may be a machine learning model that may be applied on the embedding vector associated with each item of the set of items 112 based on the received textual description (for example, the textual description 114A). The K-means clustering model 102C may cluster the determined embedding vector associated with each item of the set of items 112 into the set of labels. Further details related to the K-means clustering model 102C may be similar to the reinforcement learning model 102A without departure from the scope of the disclosure. Hence, such details have been omitted for the sake of brevity of the disclosure.

The set of items 112 may include media contents such as, video content, audio content, and closed-captioned text that may be associated with a platform such as, an over-the-top (OTT) streaming platform. In some cases, the set of items 112 may include images, text files, and the like associated with products for sale. Further, the set of items 112 may be stored in the database 106. The electronic device 102 may query for an item such as, the item 112A. The database 106 may provide the queried item 112A to the electronic device 102.

The set of textual descriptions 114 may be associated with the set of items 112. For example, the textual description 114A may be associated with the item 112A. The textual description 114B may be associated with the item 112B and so on. In an embodiment, the textual description (for example, the textual description 114B) may be associated with each item (for example, the item 112B) may include at least one of a movie plot, a genre of the item, one or more actors of the item, one or more directors of the item, a summary of the item, or a screen play of the item.

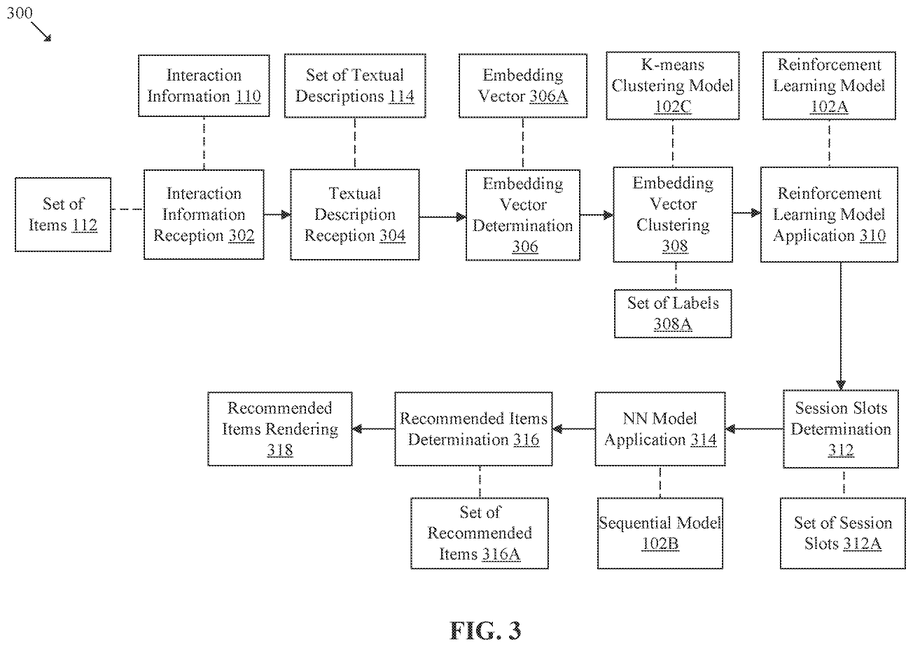

In operation, the electronic device 102 may receive the interaction information 110 of the set of users for the set of items 112. The interaction information 110 may include information of one or more items that a user of the set of users has interacted with. In case, the set of items 112 includes media content associated with an over-the-top (OTT) platform, the interaction information 110 associated with the user 116 may indicate one or more items of the set of items 112 that the user 116 may have consumed through the OTT platform. Further, the interaction information 110 associated with the user 116 may indicate a rating for each of the one or more items of the set of items 112 that the user 116 may have provided for the corresponding item. In case, the set of items 112 includes a media content associated with an e-commerce platform, the interaction information 110 associated with the user 116 may indicate one or more items of the set of items 112 that the user 116 may have wish-listed, purchased, or rated. In an example, the set of users may include a first user, a second user, and third user. Herein, the interaction information 110 may indicate a first subset of the set of items 112 that the first user may have been interacted with, a second subset of the set of items 112 that the second user may have been interacted with, and a third subset of the set of items 112 that the third user may have been interacted with. Details related to the reception of the interaction information 110 are further described, for example, in FIG. 3 (at 302).

The electronic device 102 may receive the textual description (for example, the textual description 114A) of each item (for example, the item 112A) of the set of items 112. The textual description 114A may include details associated with the item 112A. In an example, the item 112A may be a product for sale on an e-commerce platform. The textual description 114A may indicate a specification of the item 112A, a color of the item 112A, an attribute of the item 112A, a dimension of the item 112A, a selling price of the item 112A, a usage of the item 112A, and the like. In another example, the item 112A may be media content on an OTT platform. The textual description 114A may indicate an actor of the item 112A, a genre of the item 112A, a summary of the item 112A, and the like. Details related to the reception of the textual description are further described, for example, in FIG. 3 (at 304).

The electronic device 102 may determine the embedding vector associated with each item (for example, the item 112A) of the set of items 112 based on the received textual description (for example, the textual description 114A). The embedding vector associated with the item 112A may be a multi-dimensional vector that may be determined based on an extraction of a plurality of features, associated with the item 112A, from the received textual description 114A. Details related to the determination of the embedding vector are further described, for example, in FIG. 3 (at 306).

The electronic device 102 may cluster the determined embedding vector associated with each item (for example, the item 112A) of the set of items 112A into the set of labels. It may be appreciated that the clustering of dataset may divide datapoints of the dataset into groups. In an example, the electronic device 102 may use the K-means clustering model 102C to cluster the determined embedding vector. The electronic device 102 may assign a label to each item of the set of items 112 based on the clustering of the determined embedding vector associated with the corresponding item (for example, the item 112A). Details related to the clustering of the determined embedding vector are further described, for example, in FIG. 3 (at 308).

The electronic device 102 may apply the reinforcement learning model 102A on the set of labels based on the clustering of the determined embedding vector. Herein, the set of labels and the interaction information 110 may be provided as an input to the reinforcement learning model 102A. In some embodiments, the interaction information 110 may be modified based on an assignment of the set of labels to the set of items 112. The modified interaction information may be provided as a feedback input to the reinforcement learning model 102A. Details related to the application of the reinforcement learning model 102A are further described, for example, in FIG. 3 (at 310).

The electronic device 102 may determine the set of session slots associated with the received interaction information 110 of the set of users, based on the application of the reinforcement learning model 102A. The reinforcement learning model 102A may analyze the set of labels and the received interaction information 110 to determine the set of session slots. A size of a session slot associated with the user 116 may be in accordance with an interaction behavior pattern of the user 116, a mood of the user 116, and the like. Further, the set of session slots associated with the received interaction information 110 of the set of users may be determined in accordance with a set of rules. Details related to the determination of the set of session slots are further described, for example, in FIG. 3 (at 312).

The electronic device 102 may apply the sequential model 102Bon the determined set of session slots associated with the received interaction information 110 of the set of users. The sequential model 102Bmay be a recommendation model. The set of session slots associated with the received interaction information 110 may be provided as an input to the sequential model 102B. Details related to the application of the sequential model 102Bare further described, for example, in FIG. 3 (at 314).

The electronic device 102 may determine the set of recommended items for the user 116 of the set of users, based on the application of the sequential model 102B. The sequential model 102Bmay analyze the set of session slots associated with the received interaction information 110 of the set of users to determine the set of recommended items in accordance with a liking of the user 116. Details related to the determination of the set of recommended items are further described, for example, in FIG. 3 (at 316).

The electronic device 102 may render the determined set of recommended items. In an embodiment, the determined set of recommended items may be rendered on a display device associated with the electronic device 102. In another embodiment, the determined set of recommended items may be transmitted to the OTT platform. Herein, the determined set of recommended items may be rendered via the OTT platform. The user 116 to consume an item of the determined set of recommended items based on a user-selection of the corresponding item. In another embodiment, the determined set of recommended items may be transmitted to the e-commerce platform. Herein, the determined set of recommended items may be rendered via the e-commerce platform. The user 116 browse the determined set of recommended items and may purchase one or more items of the determined set of recommended items from the ecommerce platform.

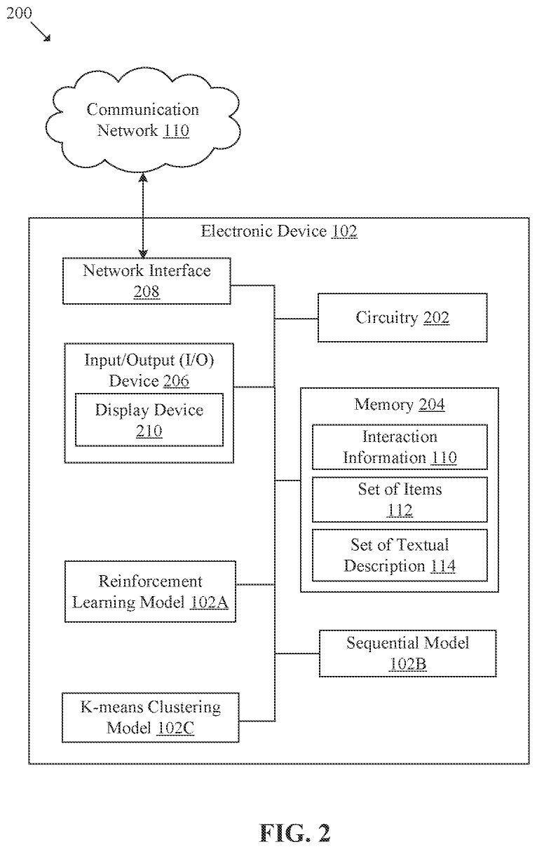

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the exemplary electronic device 102. The electronic device 102 may include circuitry 202, a memory 204, an input/output (I/O) device 206, a network interface 208, the reinforcement learning model 102A, the sequential model 102B, and the K-means clustering model 102C. The memory 204 may store the interaction information 110, the set of items 112, and the set of textual descriptions 114. The input/output (I/O) device 206 may include a display device 210.

The circuitry 202 may include suitable logic, circuitry, and/or interfaces that may be configured to execute program instructions associated with different operations to be executed by the electronic device 102. The operations may include interaction information reception, textual description reception, embedding vector determination, embedding vector clustering, reinforcement learning model application, session slots determination, NN model application, set of recommended items determination, and recommended items rendering. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be further configured to store the interaction information 110, the set of items 112, and the set of textual descriptions 114. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, interfaces, and/or code that may be configured to receive an input and provide an output based on the received input. For example, the input may include a user input indicative of a request to provide a set of recommended items that the user 116 may interact with, consume, or purchase through the OTT platform or an e-commerce platform. The output may include the determined set of recommended items. The I/O device 206 may include the display device 210. Examples of the I/O device 206 may include, but are not limited to, a display (e.g., a touch screen), a keyboard, a mouse, a joystick, a microphone, or a speaker. Examples of the I/O device 206 may further include braille I/O devices, such as, braille keyboards and braille readers.

The network interface 208 may include suitable logic, circuitry, interfaces, and/or code that may be configured to facilitate communication between the electronic device 102 and the server 104, via the communication network 108. The network interface 208 may be implemented by use of various known technologies to support wired or wireless communication of the electronic device 102 with the communication network 108. The network interface 208 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 208 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), 5^{th} Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The display device 210 may include suitable logic, circuitry, and interfaces that may be configured to display or render the determined set of recommended items. The display device 210 may be a touch screen which may enable a user (e.g., the user 116) to provide a user-input via the display device 210. The touch screen may be at least one of a resistive touch screen, a capacitive touch screen, or a thermal touch screen. The display device 210 may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 210 may refer to a display screen of a head mounted device (HMD), a smart-glass device, a see-through display, a projection-based display, an electro-chromic display, or a transparent display. Various operations of the circuitry 202 for creation of homogeneous sessions using machine learning (ML) model are described further, for example, in FIG. 3.

FIG. 3 is a diagram that illustrates an exemplary processing pipeline for creation of homogeneous sessions using machine learning (ML) model, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 318 for implementation of creation of homogeneous sessions using machine learning (ML) model. The exemplary operations 302 to 318 may be executed by any computing system, for example, by the electronic device 102 of FIG. 1 or by the circuitry 202 of FIG. 2. FIG. 3 further includes the reinforcement learning model 102A, the sequential model 102B, the K-means clustering model 102C, the interaction information 110, the set of items 112, the set of textual descriptions 114, an embedding vector 306A, a set of labels 308A, a set of session slots 312A, and a set of recommended items 316A.

At 302, an operation of interaction information reception may be executed. The circuitry 202 may be configured to receive the interaction information 110 of the set of users for the set of items 112. A user of the set of users may have interacted with one or more items of the set of items 112 according to an interest of the corresponding user. In an example, an interaction of a user such as, the user 116 with an item such as, the item 112A (for example, a movie or product), may indicate whether a user has watched or purchased the item 112A. In another example, an interaction of a user such as, the user 116 with an item such as, the item 112A (for example, a movie or a product) may indicate a rating provided by the user for the item 112A. Thus, the interaction information 110 associated with the user 116 may indicate the one or more items of the set of items 112 that the user 116 may have interacted with.

In an embodiment, a set of sessions associated with each user of the set of users may be received. Typically, a size of each session of the set of sessions associated with each user of the set of users may be fixed. In an example, a time duration of each session may be of thirty minutes. The interaction information 110 may be determined based on the received set of sessions.

In an embodiment, the received interaction information 110 may correspond to a user interaction matrix between the set of users and the set of items 112. An entry in a cell of the user interaction matrix may correspond to an interaction between a user and an item associated with the corresponding cell of the user interaction matrix. It may be appreciated that the user interaction matrix may be constructed based on the received set of sessions associated with each user of the set of users. In an example, the set of users may include a user “P” and a user “Q”. The user “P” may have interacted with the item 112A, an item 112D, and an item 112M of the set of items 112 during a first session. The user “P” may have interacted with an item 112C, an item 112E, and an item 112F of the set of items 112 during a second session. The user “Q” may have interacted with the item 112A, an item 112E, and the item 112F of the set of items 112 during the first session. The user “Q” may have interacted with the item 112C, the item 112M, and the item 112D of the set of items 112 during the second session. Thus, a number of sessions associated with each user of the set of users may be “2”. In order to determine the user interaction matrix, the user “P” and the user “Q” may be taken along “Y” direction and the set of items 112 may be taken along “X” direction. Thus, a dimension of user interaction matrix “2” rows and “N” columns. Each cell of the user interaction matrix may correspond to the interaction between the user and the item. That is, a first cell of the user interaction matrix may correspond to the interaction between the user “P” and the item 112A. As, the user “P” has interacted with the item 112A, the entry of first cell may be “1”. Similarly, a second cell of the user interaction matrix may correspond to the interaction between the user “P” and the item 112B. As, the user “P” has not interacted with the item 112A, the entry of first cell may be “0”. Similarly, entries in other cells of the user interaction matrix may be determined.

At 304, an operation of textual description information reception may be executed. The circuitry 202 may be configured to receive the textual description of each item of the set of items 112. Herein, the set of textual descriptions 114 associated with the set of items 112 may be received. A textual description (for example, the textual description 114A) of an item (for example, the item 112A) may provide a textual explanation or narrative of the corresponding item. In an example, the textual description (for example, the textual description 114A) of an item (for example, the item 112A) may be received from an OTT platform.

In an embodiment, the textual description (for example, the textual description 114A) of each item (for example, the item 112A) may include at least one of a movie plot, a genre of the item, one or more actors of the item, one or more directors of the item, a summary of the item, or a screen play of the item. The movie plot may provide information of one or more events that may take place in the movie (for example, the item 112A), in case the item is the particular movie. The genre of the item (for example, the item 112A) may indicate a type of the item (for example, the item 112A). In an example, the item (for example, the item 112A) may be a media content. Herein, the genre of the item (for example, the item 112A) may be an action movie, a romantic movie, a science fiction movie, a horror movie, a musical movie, and the like. The summary of an item may briefly describe the item. The screen play of an item may be a script of the item.

At 306, an operation of embedding vector determination may be executed. The circuitry 202 may be configured to determine the embedding vector 306A associated with each item of the set of items 112 based on the received textual description, such as, the textual description 114A. The received textual description (such as, the textual description 114A) associated with an item (such as, the item 112A) may be analyzed to determine a set of features associated with the corresponding item. The embedding vector associated with the item 112A may be a multi-dimensional vector that may be determined based on an extraction of a plurality of features, associated with the item 112A, from the received textual description 114A. In an example, in case the item 112A is a product or service sold through an e-commerce platform, the plurality of features associated with the item 112A may be the specification of the item 112A, the color of the item 112A, the attribute of the item 112A, the dimension of the item 112A, the selling price of the item 112A, the usage of the item 112A, and the like. In another example, in case the item 112A is media content hosted on an OTT platform, the plurality of features associated with the item 112A may be the actor of the item 112A, the genre of the item 112A, a length of the item 112A, and the like.

At 308, an operation of embedding vector clustering may be executed. The circuitry 202 may be configured to cluster the determined embedding vector 306A associated with each item of the set of items 112 into the set of labels 308A. It may be appreciated that the clustering may be a technique that may group an unlabeled dataset into a set of clusters. The determined embedding vector 306A associated with each item of the set of items 112 may be clustered into the set of labels 308A. Herein, the set of labels may be a set of groups into which the determined embedding vector 306A associated with each item of the set of items 112 may be clustered.

In an embodiment, the clustering of the determined embedding vector 306A may be based on the K-means clustering model 102C. The K-means clustering model 102C may be a machine learning model that may employ an unsupervised learning algorithm such as, an elbow method, for clustering the determined embedding vector 306A associated with each item of the set of items 112 into the set of labels 308A.

In an embodiment, the circuitry 202 may be configured to determine the set of clusters associated with the set of items 112, based on the determined embedding vector 306A associated with each item of the set of items 112. Herein, the elbow method may be applied on the determined embedding vector 306A associated with each item of the set of items 112. Thereafter, the set of clusters associated with the set of items 112 may be determined. In an example, “k” number of clusters may be determined.

The circuitry 202 may be further configured to determine a centroid associated with each cluster of the determined set of clusters. Upon determination of the set of clusters, the centroid associated with each cluster of the determined set of clusters may be determined randomly. In an example, “k” number of centroids may be determined from a set of determined embedding vectors associated with set of items 112. In another example, the “k” number of centroids may be determined that may be different from the set of determined embedding vectors.

The circuitry 202 may be further configured to determine a distance of each item from the determined centroid associated with each cluster of the determined set of clusters. Herein, the distance may be Euclidean Distance, Manhattan Distance, Minkowski Distance, or Hamming Distance. For example, the Euclidean Distance of the item 112A from each of the “k” number of centroids may be determined. Similarly, the Euclidean Distance of the item 112B from each of the “k” number of centroids may be determined.

The circuitry 202 may be further configured to determine a cluster closest to each item based on the determined distance. Herein, the determined distance of each item from the determined centroid associated with each cluster of the determined set of clusters may be analyzed to determine a closest cluster for each item. In an example, the number of centroids may be four. The Euclidean Distance of the item 112A from a first centroid may be “2.7” units, the Euclidean Distance of the item 112A from a second centroid may be “1.1” units, the Euclidean Distance of the item 112A from a third centroid may be “3.2” units, the Euclidean Distance of the item 112A from a fourth centroid may be “2.9” units. Thus, the second centroid may be closest to the item 112A. Similarly, the centroid closet to each of the other item of the set of items 112 may be determined.

The circuitry 202 may be further configured to assign a label to each item of the set of items based on the determined closest cluster, wherein the clustering of the determined embedding vector into the set of labels 308A may be further based on the assignment of the label to each item. The label may be a name of a cluster. In an example, the second centroid may be closest to the item 112A. Thus, the label assigned to the item 112A may be “second”.

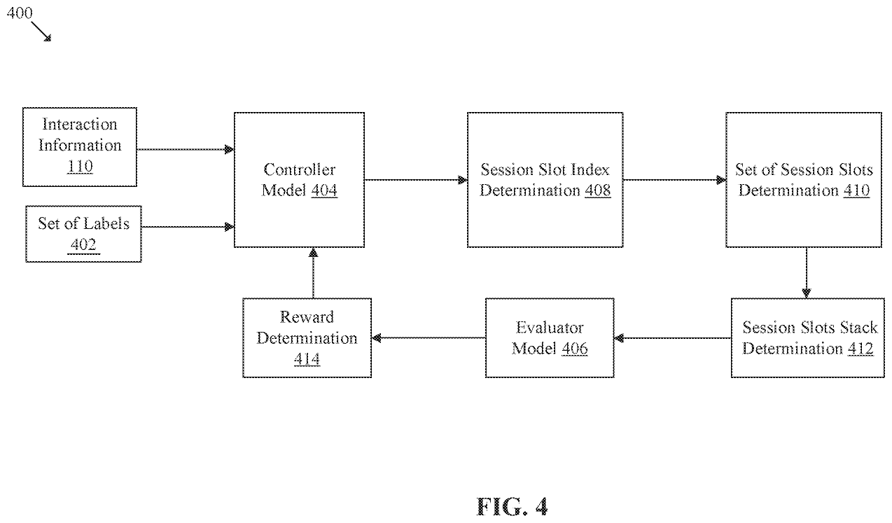

At 310, an operation of reinforcement learning model application may be executed. The circuitry 202 may be configured to apply the reinforcement learning model 102A on the set of labels 308A based on the clustering of the determined embedding vector 306A. Herein, the determined set of labels 308A may be provided as an input to the reinforcement learning model 102A. Details related to the application of the reinforcement learning model 102A are further provided, for example, in FIG. 4.

At 312, an operation of the set of session slots determination may be executed. The circuitry 202 may be configured to determine the set of session slots 312A associated with the received interaction information 110 of the set of users, based on the application of the reinforcement learning model 102A. In an embodiment, upon determination of the set of labels 308A, the interaction information 110 along with the determined set of labels 308A may be provided as input to the reinforcement learning model 102A. That is, the interaction information 110, such as, the user interaction matrix, may be modified by replacement of each item of the set of items 112 with the determined label associated with the corresponding item. The modified interaction information may be provided as an input to the reinforcement learning model 102A. The reinforcement learning model 102A may analyze the modified interaction information to determine the set of session slots 312A. Herein, the length of a session slot may be different from the other session slots of the set of session slots 312A. That is, a duration of each session slot for each user may be different and may be based on a mood, a choice, an interaction behavioral pattern of the user. Further, each of the determined set of session slots 312A may be a homogeneous session slot. That is, a number of dominating item in each of the determined set of session slots 312A may be one.

In an embodiment, the reinforcement learning model 102A may comprise a controller model configured to determine the set of sessions slots (for example, the set of sessions slots 312A) associated with each user of the set of users based on a set of rules. The reinforcement learning model 102A may further comprise an evaluator model configured to reward or penalize the controller model based on the set of rules. The controller model may be a machine learning model that may be applied on the set of the labels 308A. The controller model may analyze the interaction information 110 and the set of labels 308A to determine the set of sessions slots 312A associated with each user based on the set of rules. The evaluator model may be a machine learning model that may be applied on the determined set of sessions slots 312A. The evaluator model may evaluate the determined set of sessions slots 312A to determine whether the determined set of sessions slots 312A may be in accordance with the set of rules. In case, the determined set of sessions slots 312A is in accordance with the set of rules, then the evaluator model may reward the controller model. In case, the determined set of sessions slots 312A violates at least one rule of the set of rules, then the evaluator model may penalize the controller model. In such cases, the controller model may analyze the interaction information 110, the set of labels 308A, and the determined set of sessions slots 312A to determine an optimal set of sessions slots.

In an embodiment, the set of rules may comprise at least one of: a first rule corresponding to a session slot being a set of user-item interaction time stamps, a second rule corresponding to a domination of one item of the set of items 112 in a session slot, a third rule corresponding to a difference of dominating items between two consecutive session slots, a fourth rule corresponding to a minimum number of items in a session slot being equal to two, or a fifth rule corresponding to a flexibility of a size of a session slot.

The first rule may state that the session slot may be the set of user-item interaction time stamps. That is, a given session slot may indicate one or more items that a user interacts with at one or more time stamps. For example, a session slot may indicate that from a time stamp “To” to a time stamp “T” the user 116 may have interacted with the item 112A, from a time stamp “T1” to a time stamp “T2”, the user 116 may have interacted with the item 112B, and from a time stamp “T2” to a time stamp “T3” the user 116 may have interacted with the item 112D.

The second rule may state that only one item of the set of items 112 may dominate in the session slot. In an example, items of comedy genre may dominate in the session slot. For example, the session slot may indicate that the user may have interacted with the item 112A, the item 112B, the item 112D, the item 112L, the item 112N. The item 112A, the item 112D, the item 112L, and the item 112N may be musical movies featuring an actor “John”. The item 112B may be a comedy movie featuring an actor “Greg”. Thus, a number of domination items in the session slot may be “1”.

The third rule may state that dominating items for the two consecutive session slots may be different. In an example, the set of session slots 312A may a first session slot and a second session slot. A dominating item for the first session slot may be an action movie and a dominating item for the first session slot may be a comedy movie.

The fourth rule may state that the minimum number of items in the session slot may be equal to two. The session slot may indicate a behavioral pattern, a liking, and a choice of the user 116. For example, the session slot may indicate that the user may like the comedy movies featuring an actor “X”. In order to deduce a liking of the user 116, the session slot may include at least two items.

The fifth rule may state that the size of the session slot may be flexible. Typically, a size of the session slot may be fixed. For example, a conventional session slot may be “30” minutes. However, the size of the session slot of the present disclosure may be customized based on the received interaction information 110. In an example, the item 112A, the item 112B, the item 112C, the item 112D, item 112E, the item 112F may be of the comedy genres featuring an actress “Mary”. The item 112G, an item 112H, an item 112I, an item 112J, an item 112K, the item 112L, the item 112M, and the item 112N may be of the horror genres featuring an actor “George”. Further, the received interaction information 110 may state that a first user (for example, the user 116) may have interacted with the item 112A, the item 112B, the item 112C, the item 112D, the item 112F, the item 112G, the item 112J, the item 112K, and the item 112L of the set of items 112 sequentially. The received interaction information 110 may further state that a second user (for example, the user 116) may have interacted with the item 112A, the item 112B, the item 112D, the item 112E, the item 112G, the item 112H, the item 112M, the item 112N, the item 112F, and the item 112C sequentially. The first user may initially view the items of the comedy genre and then may view the items of horror genre. As a transition in an item type may occur when the first user may switch from the comedy genre to the horror genre, a first session associated with the first user may include the item 112A, the item 112B, the item 112C, the item 112D and the item 112F. The second session associated with the first user may include item 112J, the item 112K, and the item 112L. In case, each item may be of “1” minutes, a length of the first session associated with the first user may be “5” minutes and a length of the second session associated with the first user may be “3” minutes. Similarly, the second user may initially view the items of the comedy genre, then may view the items of horror genre and finally the second user may switch back to the item of the comedy genre. Thus, a first session associated with the second user may include the item 112A, the item 112B, the item 112D, the item 112E. A second session associated with the second user may include the item 112G, the item 112H, the item 112M, and the item 112N. A third session associated with the second user may include the item 112F and the item 112C. Thus, a length of the first session associated with the first user may be “4” minutes and a length of the second session associated with the first user may be “4” minutes, a length of the third session associated with the first user may be “2” minutes. Thus, the size of the session slot may be flexible based on an interaction behavior of a user, a mood of the user, a liking of the user, and the like.

In an embodiment, the circuitry 202 may be further configured to apply the controller model on the set of labels 308A. The circuitry 202 may be further configured to determine a session slot index based on the application of the controller model. The determination of the set of session slots 312A may be further based on the determined session index. The circuitry 202 may be further configured to apply the evaluator model on each session slot of the determined set of session slots 312A. The circuitry 202 may be further configured to determine an evaluation result based on the application of the evaluator model. The controller model may be configured to optimize the set of session slots 312A based on the determined evaluation result. Based on the set of labels 308A and the received interaction information 110, modified interaction information associated with each user of the set of users may be determined. The modified interaction information may include a sequentially arranged set of items. Each item of the sequentially arranged set of items may be labeled according to the set of labels 308A. The modified interaction information may be provided as input to the controller model for policy creation. Based on the application of the controller model, the session slot index may be determined. The session slot index may be an index of a session slot in the set of session slots 312A. Upon determination of the session slot index, the session slot associated with the determined session slot index for a user may be determined. In an example, the session slot index may be “3”. Herein, a third session slot may be determined for the user 116. Similarly, each of the other session slots of the set of session slots 312A may be determined. Thereafter, the evaluator model may be applied on each of the set of session slots 312A. The evaluator model may analyze the each of the set of session slots 312A to determine the evaluation result. Based on the evaluation result, the controller model may be either rewarded or penalized.

In an embodiment, the circuitry 202 may be further configured to determine a number of dominating items in each session slot of the set of session slots 312A. The circuitry 202 may be further configured to determine whether the number of dominating items (i.e., a dominating category of items) in each session slot of the set of session slots 312A is one. The circuitry 202 may be further configured to determine the evaluation result as zero or a positive number based on the determination that the number of dominating item in each session slot of the set of session slots 312A is one. Upon determination of the set of session slots 312A, the determined set of session slots 312A may be provided to the evaluator model. The evaluator model may analyze each session of the determined set of session slots 312A to determine whether the number of dominating items in each session slot of the set of session slots 312A is one. In case the number of dominating items in each session slot of the set of session slots 312A is one, then it may be determined that the controller model may have followed the third rule of the set of rules during a process of determination of the set of session slots 312A. Thus, in such cases, the controller model may be rewarded. Herein, the evaluation result may be determined as zero or the positive number such as, “1”.

In an embodiment, the circuitry 202 may be further configured to determine the evaluation result as a negative number based on the determination that the number of dominating items in each session slot of the set of session slots is more than one.

In case the number of dominating items in each session slot of the set of session slots 312A is more than one, then it may be determined that the controller model may have skipped or not applied the third rule of the set of rules during a process of determination of the set of session slots 312A. Thus, in such cases, the controller model may be penalized. Herein, the evaluation result may be determined as a negative number, such as, “−1”. The controller model may then optimize the set of session slots 312A based on the determined evaluation result so that the optimized set of session slots may be in accordance with the third rule of the set of rules.

At 314, an operation of the NN model application may be executed. The circuitry 202 may be configured to apply the sequential model 102Bon the set of session slots 312A associated with the received interaction information 110 of the set of users. The sequential model 102Bmay be a machine learning model that may be used for a recommendation task. The set of session slots 312A associated with the received interaction information 110 of the set of users may be provided as an input to the sequential model 102B. In an embodiment, the sequential model 102Bmay be at least one of a hierarchical recurrent neural network (HRNN), a recurrent neural network (RNN), a short-term attention/memory priority (STAMP) model, a neural attentive recommendation machine (NARM) model, or a transformer model.

At 316, an operation of recommended items determination may be executed. The circuitry 202 may be configured to determine the set of recommended items 316A for the user 116 of the set of users, based on the application of the sequential model 102B. The sequential model 102Bmay analyze the set of session slots 312A to determine the set of recommended items 316A for the user 116. The set of recommended items 316A for the user 116 may be in accordance with a set of characteristics, such as, a liking of the user 116, a mood of the user 116, and the like associated with the user 116. In an example, according to the set of session slots 312A, the sequential model 102Bmay deduce that the user 116 may like an item of comedy genre featuring an actor “A”. Thereafter, an item “X”, an item “Y”, and an item “Z” that may be of comedy genre and may feature the actor “A” may be determined.

At 316, an operation of recommended items rendering may be executed. The circuitry 202 may be configured to render the determined set of recommended items 316A. In an embodiment, the determined set of recommended items 316A may be rendered on the display device 210. For example, the determined set of recommended items 316A may include the item 112A, an item 112G, and an item 112L of the set of items 112. A user interface (UI) associated with an over-the-air (OTA) application or an over-the-top (OTT) platform may be displayed on the display device 210. The UI may include a first UI element associated with the item 112A, a second UI element associated with the item 112G, and a third UI element associated with the item 112L. A user input including a user-selection of the item 112G from the determined set of recommended items 316A may be received based on an interaction of the user 116 with the second UI element. Thereafter, based on the received user input, the item 112G may be rendered on the display device 210.

The disclosed electronic device 102 may thus employ the ML model for creation of homogeneous sessions. The electronic device 192 may employ the reinforcement learning model 102A to determine the set of session slots 312A associated with the received interaction information 110 of the set of users. A length of each session slot of the determined set of session slots 312A may be customized according to an interaction pattern of a user (for example, the user 116) associated with the corresponding session slot. That is, a size of two or more session slots of the set of session slots may differ. In an example, the set of users may include a teenage user and a middle-aged user. The teenage user may have an erratic interaction behavior and the middle-aged user may have a stable interaction behavior. That is, the teenage user may switch from one type of item to another quicker than the middle-aged user. Therefore, the size of the determined set of session slots 312A associated with the teenage user may be smaller than the size of the determined set of session slots 312A associated with the middle-aged user. Further, the size of the determined set of session slots 312A may vary according to a mood of the user associated with the set of session slots 312A. The determined set of session slots 312A may be applied as an input to the sequential model 102B for determination of the set of recommended items 316A for the user116 of the set of users. The set of recommended items 316A, such as, movies may be rendered on an over-the-top (OTT) platform. Further, in some cases, the set of recommended items 316A may be rendered on an e-commerce platform. The set of recommended items 316A may be then analyzed and one or more items of the set of recommended items 316A may be purchased by the user 116. Further, in some embodiments, a maximum number of a dominating category in each session slot of the determined set of session slots 312A may be “1”. Such restrictions may enable the sequential model 102Bto recommend the set of recommended items 316A that may be optimal and in accordance with a liking of the user 116. Thus, as each session slot may correspond to a single type of items (e.g., an action movie, or comedy movie), the recommendations made based on such homogenous slots may have a higher accuracy and relevance for the particular user. In other words, cohesive session slots with a single dominating category of items may help to recommend items that may be more likable to the users.

FIG. 4 is a diagram that illustrates an exemplary scenario for determination of set of session slots, in accordance with an embodiment of the disclosure. FIG. 4 is described in conjunction with elements from FIG. 1, FIG. 2, and FIG. 3. With reference to FIG. 4, there is shown an exemplary scenario 400. The scenario 400 may include the interaction information 110, a set of labels 402, a controller model 404, and an evaluator model 406. FIG. 4 further includes an operation 408, an operation 410, an operation 412, and an operation 414 that may be executed by any computing system, for example, by the electronic device 102 of FIG. 1 or by the circuitry 202 of FIG. 2. A set of operations associated with the scenario 400 is described herein.

With reference to FIG. 4, the set of labels 402 and the interaction information 110 may be provided as the input to the controller model 404. In an embodiment, based on the set of labels 308A and the received interaction information 110, the modified interaction information associated with each user (for example, the user 116) of the set of users may be determined. The modified interaction information may include the sequentially arranged set of items. Each item of the sequentially arranged set of items may be labeled according to the set of labels 308A. The modified interaction information may be provided as input to the controller model 404 for policy creation.

At 408, an operation of session slot index determination may be executed. The circuitry 202 may be configured to determine the session slot index based on the application of the controller model 404. The session slot index may be an index of a session slot in the set of session slots 312A. In an example, the determined session slot index may be “5”.

At 408, an operation of set of session slots determination may be executed. The circuitry 202 may be configured to determine the set of session slots 312A further based on the determined session index. In an example, the session slot index may be “5”. Herein, a fifth session slot may be determined for the user 116. Similarly, each of the other session slot of the set of session slots 312A for the user 116 may be determined. Each session slot may be determined based on the set of rules.

At 410, an operation of session slots stack determination may be executed. The circuitry 202 may be configured to stack the determined set of session slots 312A. In an example, a number of session slots in the determined set of session slots 312A may be “10”. Herein, the “10” number of the session slots may be stacked together to determine stacked set of session slots. The stacked set of session slots may be provided as an input to the evaluator model 406. The evaluator model 406 may analyze each session slot of the determined set of session slots 312A using the set of rules to determine the evaluation result. In case, each session slot of the determined set of session slots 312A is in accordance with the set of rules, then the evaluator model 406 may reward the controller model 404. In case, at least one session slot of the determined set of session slots 312A violates at least one rule of the set of rules, then the evaluator model 406 may penalize the controller model 404. The evaluation result may be fed back to the controller model 404. The controller model 404 may update the policy associated with the controller model 404 based on the feedback. Thereafter, the controller model 404 may optimize the set of session slots 312A based on the determined evaluation result.

It should be noted that scenario 400 of FIG. 4 is for exemplary purposes and should not be construed to limit the scope of the disclosure.

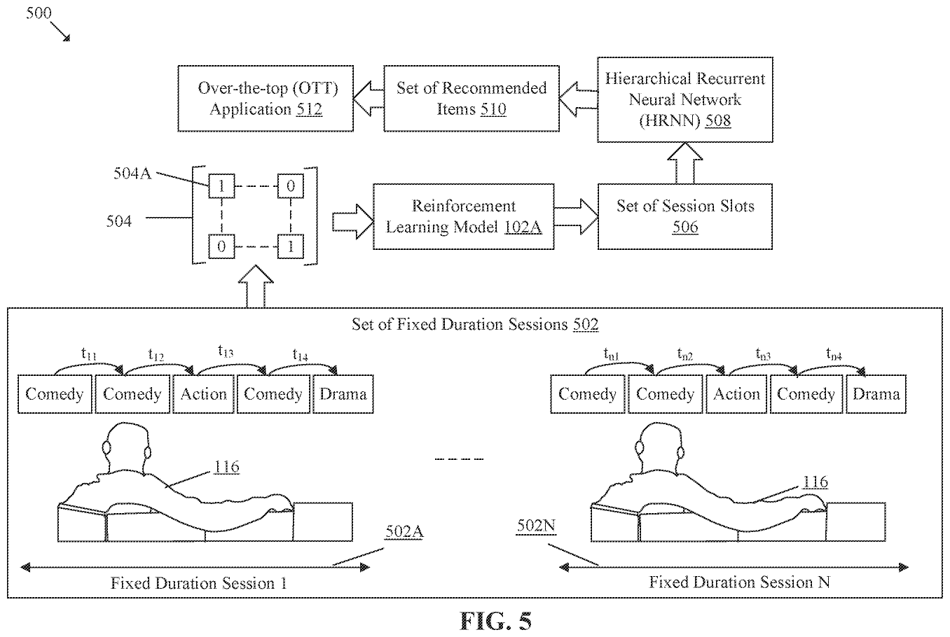

FIG. 5 is a diagram that illustrates an exemplary scenario for creation of homogeneous sessions using machine learning (ML) model, in accordance with an embodiment of the disclosure. FIG. 5 is described in conjunction with elements from FIG. 1, FIG. 2, FIG. 3, and FIG. 4. With reference to FIG. 5, there is shown an exemplary scenario 500. The scenario 500 may include a set fixed duration sessions 502, a user interaction matrix 504, a set of session slots 506, a hierarchical recurrent neural network (HRNN) 508, a set of recommended items 510, an over-the-top (OTT) application 512, and the reinforcement learning model 102A. The set fixed duration sessions 502 may include a fixed duration session 502A . . . a fixed duration sessions 502N.

The N number of fixed duration sessions shown in FIG. 5 are presented merely as an example. The database 106 may include information about only two or more than N fixed duration sessions, without deviation from the scope of the disclosure. For the sake of brevity, only N fixed duration sessions have been shown in FIG. 5. However, in some embodiments, there may be more than N fixed duration sessions without limiting the scope of the disclosure. In FIG. 5, there is further shown a user 116, who may be associated with or may operate the electronic device 102. A set of operations associated with the scenario 500 is described herein.

With reference to FIG. 5, the set fixed duration sessions 502 may be associated with the user 116. A size of each fixed duration session of the set fixed duration sessions 502 associated with the user 116 may be the same. For example, a time duration of each fixed duration session of the set fixed duration sessions 502 may be “15” minutes. Further, each fixed duration session may include a plurality of time stamps at which the user 116 may have switched from one item to another item. For example, the fixed duration session 502A may include a time stamp t11, a time stamp t12, a time stamp t13, and a time stamp time stamp t14. At the time stamp t11, the user 116 may have switched from a first comedy item to a second comedy item of the set of items 112. At the time stamp t12, the user 116 may have switched from the second comedy item to a first action item of the set of items 112. At the time stamp t13, the user 116 may have switched from the first action item to a third comedy item of the set of items 112. At the time stamp t14, the user 116 may have switched from the third comedy item to a first drama item of the set of items 112.

Based on the set fixed duration sessions 502 the user interaction matrix 504 may be constructed. The set of items 112 may be taken along a horizontal axis of the user interaction matrix 504 and the set of users may be taken along a vertical axis of the user interaction matrix 504. Further, each cell of the user interaction matrix 504 may correspond to the interaction between a user and an item associated with the corresponding cell of the user interaction matrix 504. For example, the cell 504A may indicate an interaction of a first user, such as, the user 116 of the set of users, with the item 112A of the set of items 112. The entry in the cell 504A may be “1”. Thus, the user 116 may have interacted with the item 112A. In case the entry in a cell is “0” then there may be no interaction between a user and an item associated with the corresponding cell.

The user interaction matrix 504 may be provided as input to the reinforcement learning model 102A. Based on an application of the reinforcement learning model 102A, the set of session slots 506 associated with the user interaction matrix 504 may be determined. The set of session slots 506 may be customized based on the interaction behavior of each user of the set of users. The set of session slots 506 associated with the user interaction matrix 504 of the set of users may be provided as an input to the HRNN 508. The HRNN 508 may analyze the set of session slots 506 and provide the set of recommended items 510 for the user 116 as an output. The set of recommended items 510 may be rendered on the over-the-top application 512. The user 116 may consume an item of his/her choice based on selection of the corresponding item from the set of recommended items 510.

It should be noted that scenario 500 of FIG. 5 is for exemplary purposes and should not be construed to limit the scope of the disclosure.

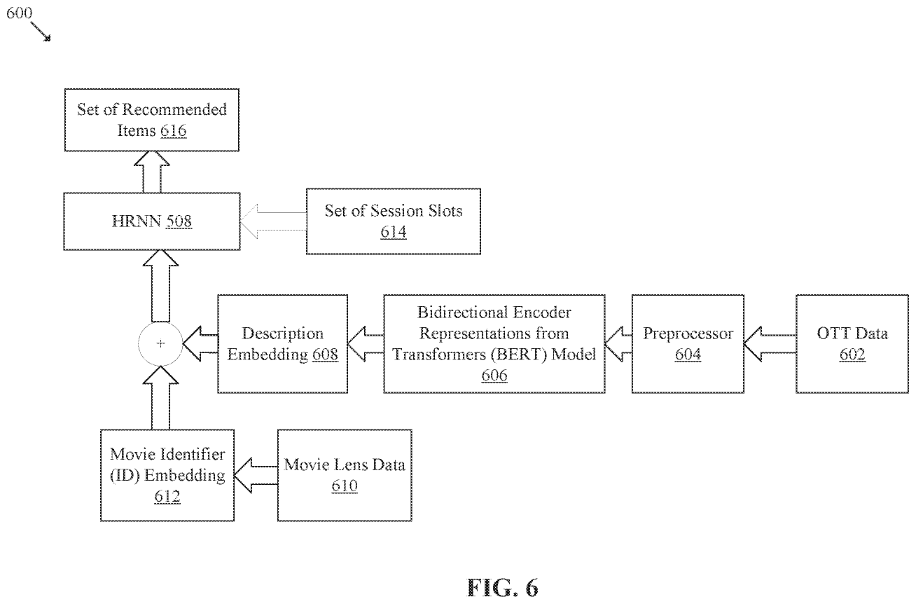

FIG. 6 is a diagram that illustrates an exemplary scenario for recommendation of items based on an application of a hierarchical recurrent neural network (HRNN), in accordance with an embodiment of the disclosure. FIG. 6 is described in conjunction with elements from FIG. 1, FIG. 2, FIG. 3, FIG. 4, and FIG. 5. With reference to FIG. 6, there is shown an exemplary scenario 600. The scenario 600 may include OTT data 602, a preprocessor 604, a bidirectional encoder representation from transformer (BERT) model 606, a description embedding 608, movie lens data 610, a movie identifier (ID) embedding 612, the HRNN 508, a set of session slots 614, and a set of recommended items 616. A set of operations associated with the scenario 600 is described herein.

The OTT data 602 may be received from the OTT application (for example, the OTT application 512). In an example, the OTT data 602 may include a textual description of media content (i.e., items) hosted on an OTT platform. The preprocessor 604 may preprocess the OTT data 602. For example, the preprocessor 604 may apply various natural language processing techniques required to preprocess the OTT data 602 to text that may be input to the BERT model 606. In an example, the preprocessor 604 may execute steps such as, tokenization, case conversion, stop words removal, stemming, lemmatization, and the like. The preprocessed OTT data 602 may be provided as an input to the BERT model 606. Based on the application of the BERT model 606 on the preprocessed OTT data 602, the description embedding 608 may be determined. Further, the circuitry 202 may receive the movie lens data 610, which may correspond to a dataset of movie ratings or tags by a large number (e.g., thousands) of users. Based on the received movie lens data 610, the movie identifier (ID) embedding 612 may be determined. The set of session slots 614 may be associated with the user 116 and may be determined as described, for example, in FIG. 3 (at 312). The determined movie identifier (ID) embedding 612 and the set of session slots 614 may be provided as an input to the HRNN 508. The HRNN 508 may output the set of recommended items 616 for the user, for example, the user 116.

It should be noted that scenario 600 of FIG. 6 is for exemplary purposes and should not be construed to limit the scope of the disclosure.

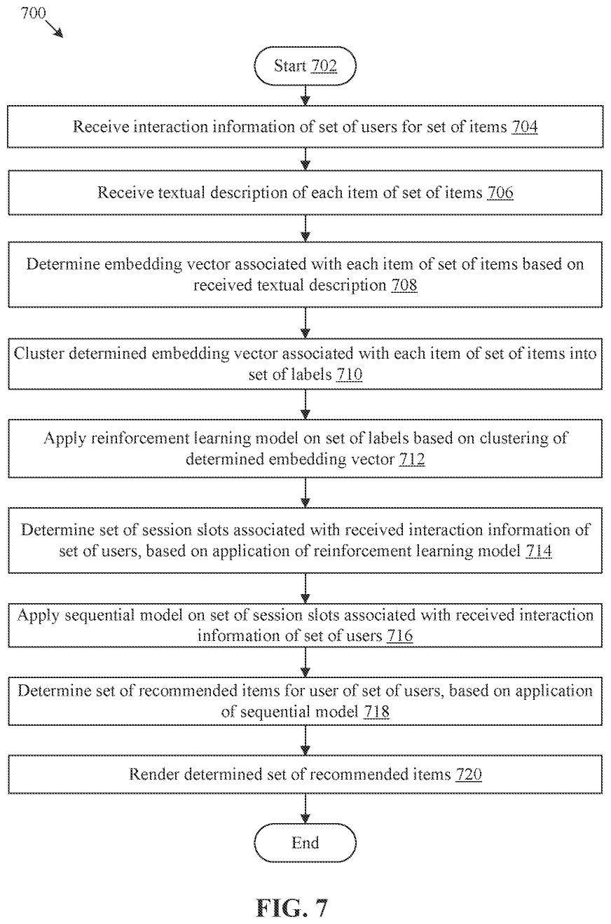

FIG. 7 is a flowchart that illustrates operations of an exemplary method for creation of homogeneous sessions using machine learning (ML) model, in accordance with an embodiment of the disclosure. FIG. 7 is described in conjunction with elements from FIG. 1, FIG. 2, FIG. 3, FIG. 4, FIG. 5, and FIG. 6. With reference to FIG. 7, there is shown a flowchart 700. The flowchart 700 may include operations from 702 to 720 and may be implemented by the electronic device 102 of FIG. 1 or by the circuitry 202 of FIG. 2. The flowchart 700 may start at 702 and proceed to 704.

At 704, the interaction information 110 of the set of users for the set of items 112 may be received. The circuitry 202 may be configured to receive the interaction information 110 of the set of users for the set of items 112. Details related to the reception of the interaction information 110 are further provided, for example, in FIG. 3 (at 302).

At 706, the textual description (for example, the textual description 114) of each item (for example, the item 112A) of the set of items 112 may be received. The circuitry 202 may be configured to receive the textual description (for example, the textual description 114) of each item (for example, the item 112A) of the set of items 112. Details related to the reception of the textual description 114 are further provided, for example, in FIG. 3 (at 304).

At 708, the embedding vector 306A associated with each item (for example, the item 112A) of the set of items 112 may be determined based on the received textual description (for example, the textual description 114). The circuitry 202 may be configured to determine the embedding vector 306A associated with each item (for example, the item 112A) of the set of items 112 based on the received textual description (for example, the textual description 114). Details related to the determination of the embedding vector 306A are further provided, for example, in FIG. 3 (at 306).

At 710, the determined embedding vector 306A associated with each item of the set of items 112 may be clustered into the set of labels 308A. The circuitry 202 may be configured to cluster the determined embedding vector 306A associated with each item of the set of items 112 into the set of labels 308A. Details related to the clustering of the embedding vector 306A are further provided, for example, in FIG. 3 (at 308).

At 712, the reinforcement learning model 102A may be applied on the set of labels 308A based on the clustering of the determined embedding vector 306A. The circuitry 202 may be configured to apply the reinforcement learning model 102A on the set of labels 308A based on the clustering of the determined embedding vector 306A. Details related to the application of the reinforcement learning model 102A are further provided, for example, in FIG. 3 (at 310).

At 714, the set of session slots 312A associated with the received interaction information 110 of the set of users may be determined based on the application of the reinforcement learning model 102A. The circuitry 202 may be configured to determine the set of session slots 312A associated with the received interaction information 110 of the set of users, based on the application of the reinforcement learning model 102A. Details related to the determination of the set of session slots 312A are further provided, for example, in FIG. 3 (at 312).

At 716, the sequential model 102Bmay be applied on the set of session slots 312 associated with the received interaction information 110 of the set of users. The circuitry 202 may be configured to apply the sequential model 102Bon the set of session slots 312 associated with the received interaction information 110 of the set of users. Details related to the application of the sequential model 102Bare further provided, for example, in FIG. 3 (at 314).

At 718, the set of recommended items 316A for the user 116 of the set of users may be determined based on the application of the sequential model 102B. The circuitry 202 may be configured to determine the set of recommended items 316A for the user 116 of the set of users, based on the application of the sequential model 102B. Details related to the determination of the set of recommended items 316A are further provided, for example, in FIG. 3 (at 316).

At 720, the determined set of recommended items 316A may be rendered. The circuitry 202 may be configured to render the determined set of recommended items 316A. Details related to the rendering of the set of recommended items 316A are further provided, for example, in FIG. 3 (at 318). Control may pass to end.

Although the flowchart 700 is illustrated as discrete operations, such as, 704, 706, 708, 710, 712, 714, 716, 718, and 720 the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include reception of interaction information (for example, the interaction information 110 of FIG. 1) of a set of users for a set of items (for example, the set of items 112). The operation may further include reception of a textual description (for example, the textual description 114A) of each item (for example, the item 112A) of the set of items 112. The operation may further include determination of an embedding vector (for example, the embedding vector 306A of FIG. 3) associated with each item (for example, the item 112A) of the set of items 112 based on the received textual description (for example, the textual description 114A). The operation may further include clustering the determined embedding vector 306A associated with each item (for example, the item 112A) of the set of items 112 into a set of labels (for example, the set of labels 308A of FIG. 3). The operation may further include application of a reinforcement learning model (for example, the reinforcement learning model 102A of FIG. 1) on the set of labels 308A based on the clustering of the determined embedding vector 306A. The operation may further include determination of a set of session slots (for example, the set of session slots 312A of FIG. 3) associated with the received interaction information 110 of the set of users, based on the application of the reinforcement learning model 102A. The operation may further include application a sequential model (for example, the sequential model 102Bof FIG. 1) on the set of session slots 312A associated with the received interaction information 110 of the set of users. The operation may further include determination of a set of recommended items (for example, the set of recommended items 316A of FIG. 3) for a user (for example, the user 116 of FIG. 1) of the set of users, based on the application of the sequential model 102B. The operation may further include rendering the determined set of recommended items 316A.

Exemplary aspects of the disclosure may provide an electronic device (such as, the electronic device 102 of FIG. 1) that includes circuitry (such as, the circuitry 202). The circuitry 202 may be configured to receive the interaction information 110 of the set of users for the set of items 112. The circuitry 202 may be further configured to receive the textual description (for example, the textual description 114A) of each item (for example, the item 112A) of the set of items 112. The circuitry 202 may be further configured to determine the embedding vector 306A associated with each item (for example, the item 112A) of the set of items 112 based on the received textual description (for example, the textual description 114A). The circuitry 202 may be further configured to cluster the determined embedding vector 306A associated with each item (for example, the item 112A) of the set of items 112 into the set of labels 308A. The circuitry 202 may be further configured to apply the reinforcement learning model 102A on the set of labels 308A based on the clustering of the determined embedding vector 306A. The circuitry 202 may be further configured to determine the set of session slots 312A associated with the received interaction information 110 of the set of users, based on the application of the reinforcement learning model 102A. The circuitry 202 may be further configured to apply the sequential model 102Bon the set of session slots 312A associated with the received interaction information 110 of the set of users. The circuitry 202 may be further configured to determine the set of recommended items 316A for a user (for example, the user 116 of FIG. 1) of the set of users, based on the application of the sequential model 102B. The circuitry 202 may be further configured to render the determined set of recommended items 316A.

In an embodiment, the received interaction information 110 may correspond to a user interaction matrix (for example, the user interaction matrix 504 of FIG. 4) between the set of users and the set of items 112, and an entry in a cell of the user interaction matrix 504 may correspond to an interaction between a user (for example, the user 116) and an item (for example, the item 112A) associated with the corresponding cell of the user interaction matrix 504.

In an embodiment, the textual description (for example, the textual description 114A) of each item (for example, the item 112A) may include at least one of a movie plot, a genre of the item 112A, one or more actors of the item 112A, one or more directors of the item 112A, a summary of the item 112A, or a screen play of the item 112A.

In an embodiment, the clustering of the determined embedding vector 306A may be based on a K-means clustering model (for example, the K-means clustering model 102C of FIG. 1).

In an embodiment, the circuitry 202 may be further configured to determine a set of clusters associated with the set of items 112, based on the determined embedding vector 306A associated with each item (for example, the item 112A) of the set of items 112. The circuitry 202 may be further configured to determine a centroid associated with each cluster of the determined set of clusters. The circuitry 202 may be further configured to determine a distance of each item (for example, the item 112A) from the determined centroid associated with each cluster of the determined set of clusters. The circuitry 202 may be further configured to determine a cluster closest to each item (for example, the item 112A) based on the determined distance. The circuitry 202 may be further configured to assign a label to each item of the set of items 112 based on the determined closest cluster, wherein the clustering of the determined embedding vector 306A into the set of labels 308A may be further based on the assignment of the label to each item.

In an embodiment, the reinforcement learning model 102A may comprises a controller model (for example, the controller model 404 of FIG. 4) configured to determine the set of sessions slots 312A associated with each user (for example, the user 116) of the set of users based on a set of rules, and an evaluator model (for example, the evaluator model 406 of FIG. 4) configured to reward or penalize the controller model 404 based on the set of rules.

In an embodiment, the set of rules comprises at least one of a first rule corresponding to a session slot being a set of user-item interaction time stamps, a second rule corresponding to a domination of one item of the set of items 112 in a session slot, a third rule corresponding to a difference of dominating items between two consecutive session slots, a fourth rule corresponding to a minimum number of items in a session slot being equal to two, or a fifth rule corresponding to a flexibility of a size of a session slot.

In an embodiment, the circuitry 202 may be further configured to apply the controller model 404 on the set of labels (for example, the set of labels 402 of FIG. 4). The circuitry 202 may be further configured to determine a session slot index based on the application of the controller model 404, wherein the determination of the set of session slots 312A may be further based on the determined session index. The circuitry 202 may be further configured to apply the evaluator model 406 on each session slot of the determined set of session slots 312A. The circuitry 202 may be further configured to determine an evaluation result based on the application of the evaluator model 406, wherein the controller model 404 may be configured to optimize the set of session slots 312A based the determined evaluation result.

In an embodiment, the circuitry 202 may be further configured to determine a number of dominating items in each session slot of the set of session slots 312A. The circuitry 202 may be further configured to determine whether the number of dominating items in each session slot of the set of session slots 312A is one. The circuitry 202 may be further configured to determine the evaluation result as zero or a positive number based on the determination that the number of dominating item in each session slot of the set of session slots 312A may be one.

In an embodiment, the circuitry 202 may be further configured to determine the evaluation result as a negative number based on the determination that the number of dominating items in each session slot of the set of session slots 312A may be more than one.

In an embodiment, the sequential model 102Bmay be at least one of a hierarchical recurrent neural network (HRNN) (for example, the HRNN 508 of FIG. 5), a recurrent neural network (RNN), a short-term attention/memory priority (STAMP) model, a neural attentive recommendation machine (NARM) model, or a transformer model.

The present disclosure may also be positioned in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive interaction information of a set of users for a set of items;
receive a textual description of each item of the set of items;
determine an embedding vector associated with each item of the set of items based on the received textual description;
cluster the determined embedding vector associated with each item of the set of items into a set of labels;
apply a reinforcement learning model on the set of labels based on the clustering of the determined embedding vector;
determine a set of session slots associated with the received interaction information of the set of users, based on the application of the reinforcement learning model;
apply a sequential model on the set of session slots associated with the received interaction information of the set of users;
determine a set of recommended items for a user of the set of users, based on the application of the sequential model; and
render the determined set of recommended items.

2. The electronic device according to claim 1, wherein
the received interaction information corresponds to a user interaction matrix between the set of users and the set of items, and
an entry in a cell of the user interaction matrix corresponds to an interaction between a user and an item associated with the corresponding cell of the user interaction matrix.

3. The electronic device according to claim 1, wherein the textual description of each item includes at least one of a movie plot, a genre of the item, one or more actors of the item, one or more directors of the item, a summary of the item, or a screen play of the item.

4. The electronic device according to claim 1, wherein the clustering of the determined embedding vector is based on a K-means clustering model.

5. The electronic device according to claim 1, wherein the circuitry is further configured to:
determine a set of clusters associated with the set of items, based on the determined embedding vector associated with each item of the set of items;
determine a centroid associated with each cluster of the determined set of clusters;
determine a distance of each item from the determined centroid associated with each cluster of the determined set of clusters;
determine a cluster closest to each item based on the determined distance; and
assign a label to each item of the set of items based on the determined closest cluster, wherein
the clustering of the determined embedding vector into the set of labels is further based on the assignment of the label to each item.

6. The electronic device according to claim 1, wherein the reinforcement learning model comprises:
a controller model configured to determine the set of sessions slots associated with each user of the set of users based on a set of rules, and
an evaluator model configured to reward or penalize the controller model based on the set of rules.

7. The electronic device according to claim 6, wherein the set of rules comprises at least one of:
a first rule corresponding to a session slot being a set of user-item interaction time stamps,
a second rule corresponding to a domination of one item of the set of items in a session slot,
a third rule corresponding to a difference of dominating items between two consecutive session slots,
a fourth rule corresponding to a minimum number of items in a session slot being equal to two, or
a fifth rule corresponding to a flexibility of a size of a session slot.

8. The electronic device according to claim 6, wherein the circuitry is further configured to:
apply the controller model on the set of labels;
determine a session slot index based on the application of the controller model, wherein
the determination of the set of session slots is further based on the determined session index;
apply the evaluator model on each session slot of the determined set of session slots; and
determine an evaluation result based on the application of the evaluator model, wherein
the controller model is configured to optimize the set of session slots based the determined evaluation result.

9. The electronic device according to claim 8, wherein the circuitry is further configured to:
determine a number of dominating items in each session slot of the set of session slots;
determine whether the number of dominating items in each session slot of the set of session slots is one; and
determine the evaluation result as zero or a positive number based on the determination that the number of dominating item in each session slot of the set of session slots is one.

10. The electronic device according to claim 9, wherein the circuitry is further configured to determine the evaluation result as a negative number based on the determination that the number of dominating items in each session slot of the set of session slots is more than one.

11. The electronic device according to claim 1, wherein the sequential model is at least one of a hierarchical recurrent neural network (HRNN), a recurrent neural network (RNN), a short-term attention/memory priority (STAMP) model, a neural attentive recommendation machine (NARM) model, or a transformer model.

12. A method, comprising:
in an electronic device:
receiving interaction information of a set of users for a set of items;
receiving a textual description of each item of the set of items;
determining an embedding vector associated with each item of the set of items based on the received textual description;
clustering the determined embedding vector associated with each item of the set of items into a set of labels;
applying a reinforcement learning model on the set of labels based on the clustering of the determined embedding vector;
determining a set of session slots associated with the received interaction information of the set of users, based on the application of the reinforcement learning model;
applying a sequential model on the set of session slots associated with the received interaction information of the set of users
determining a set of recommended items for a user of the set of users, based on the application of the sequential model; and
rendering the determined set of recommended items.

13. The method according to claim 12, wherein
the received interaction information corresponds to a user interaction matrix between the set of users and the set of items, and
an entry in a cell of the user interaction matrix corresponds to an interaction between a user and an item associated with the corresponding cell of the user interaction matrix.

14. The method according to claim 12, wherein the textual description of each item includes at least one of a movie plot, a genre of the item, one or more actors of the item, one or more directors of the item, a summary of the item, or a screen play of the item.

15. The method according to claim 12, wherein the clustering of the determined embedding vector is based on a K-means clustering model.

16. The method according to claim 12, further comprising:
determining a set of clusters associated with the set of items, based on the determined embedding vector associated with each item of the set of items;
determining a centroid associated with each cluster of the determined set of clusters;
determining a distance of each item from the determined centroid associated with each cluster of the determined set of clusters;
determining a cluster closest to each item based on the determined distance; and
assigning a label to each item of the set of items based on the determined closest cluster, wherein
the clustering of the determined embedding vector into the set of labels is further based on the assignment of the label to each item.

17. The method according to claim 12, wherein the reinforcement learning model comprises:
a controller model configured to determine the set of sessions slots associated with each user of the set of users based on a set of rules, and
an evaluator model configured to reward or penalize the controller model based on the set of rules.

18. The method according to claim 17, wherein the set of rules comprises at least one of:
a first rule corresponding to a session slot being a set of user-item interaction time stamps,
a second rule corresponding to a domination of one item of the set of items in a session slot,
a third rule corresponding to a difference of dominating items between two consecutive session slots,
a fourth rule corresponding to a minimum number of items in a session slot being equal to two, or
a fifth rule corresponding to a flexibility of a size of a session slot.

19. The method according to claim 17, further comprising:
applying the controller model on the set of labels;
determining a session slot index based on the application of the controller model, wherein
the determination of the set of session slots is further based on the determined session index;
applying the evaluator model on each session slot of the determined set of session slots; and
determining an evaluation result based on the application of the evaluator model, wherein
the controller model is configured to optimize the set of session slots based the determined evaluation result.

20. A non-transitory computer-readable medium having stored thereon, computer-executable instructions that when executed by an electronic device, causes the electronic device to execute operations, the operations comprising:
receiving interaction information of a set of users for a set of items;
receiving a textual description of each item of the set of items;
determining an embedding vector associated with each item of the set of items based on the received textual description;
clustering the determined embedding vector associated with each item of the set of items into a set of labels;
applying a reinforcement learning model on the set of labels based on the clustering of the determined embedding vector;
determining a set of session slots associated with the received interaction information of the set of users, based on the application of the reinforcement learning model;
applying a sequential model on the set of session slots associated with the received interaction information of the set of users;
determining a set of recommended items for a user of the set of users, based on the application of the sequential model; and
rendering the determined set of recommended items.
